(19) United States
(12) Patent Application Publication
(10) Pub. No.: US 2006/0032404 A1
(43) Pub. Date: Feb. 16, 2006

(54) Mixture of interference pigments

(76) Inventor: Helge Bettina Kniess, Weiterstadt (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/189,011

(22) Filed: Jul. 26, 2005

(30) Foreign Application Priority Data
Jul. 27, 2004 (DE) 102004036297.1

(51) Int. Cl. C09D 11/00; C04B 14/04

(52) U.S. Cl. 106/481; 106/31.6; 106/31.9

(57) ABSTRACT

The present invention relates to a silver and color-neutral pigment mixture comprising weakly colored silver interference pigments A and weakly colored interference pigments B of a complementary color, to the use thereof in cosmetics, paints, coatings, plastics, films, in security printing, in security features in documents and identity cards, for coloring seed, for coloring foods or in medicament coatings and for the preparation of pigment compositions and dry preparations, and to cosmetics, paints, coatings, plastics, films, security features in documents and identity cards, seed, food or medicament coatings and pigment compositions and dry preparations comprising the pigment mixture according to the invention.

The present invention relates to a silver and color-neutral pigment mixture comprising weakly colored silver interference pigments A and weakly colored interference pigments B of a complementary color, to the use thereof in cosmetics, paints, coatings, plastics, films, in security printing, in security features in documents and identity cards, for coloring seed, for coloring foods or in medicament coatings and for the preparation of pigment compositions and dry preparations, and to cosmetics, paints, coatings, plastics, films, security features in documents and identity cards, seed, food or medicament coatings and pigment compositions and dry preparations comprising the pigment mixture according to the invention.

Silver-colored articles are encountered in all areas of daily need. This applies, in particular, to automobiles, but also to many other articles, for example made from plastics. In addition, a silver appearance is also in demand in the use of paints, for example for buildings and the like. Besides the classical metal-effect pigments, interference pigments are also suitable for producing this optical impression. In contrast to the case in metal-effect pigments, where the optical effect is based on reflection at the surface of the metallic core, the optical impression of the interference pigments in accordance with DIN 55944 is based on the phenomenon of light interference, as, for example, in the case of pigments comprising titanium dioxide on mica. The interference pigments have the advantage over metal-effect pigments that they have variable transparency through the corresponding choice of the substrate cores and the coating applied thereto, which is not possible in the case of metal-effect pigments owing to the metal core, which is fundamentally opaque. The adjustable transparency of the interference pigments makes additional design options available to the user, for example through combination with coloring systems, which may also be located beneath the layer comprising interference pigments in the particular applications. This applies, in particular, to the automobile sector, where the overall impression of the paint is achieved through combination of various optical effects in the individual paint layers.

Multilayered interference pigments usually only allow color-neutral silver shades to be achieved with difficulty, i.e. silver interference pigments generally exhibit a color cast, for example a pale blue or greenish coloration. A color cast of this type can be compensated by the admixture of a certain amount of a pigment of a complementary color. However, this results in a loss of luster, which is particularly disadvantageous precisely in the case of silver pigments since particularly high luster is desired here. In order to counter this, it is possible to use a pigment of a complementary color with the greatest possible color intensity for blending in order in this way to minimise the amount necessary for neutralization of the color cast. However, the use of an intensely colored pigment requires high precision in the blending in order to avoid achieving the opposite effect of coloration in the direction of the complementary color. In addition, the individual pigment particles in a mixture of intensely colored pigments and pigments which are significantly different in coloristic terms are frequently perceptible as separate color dots. This causes the original homogeneous appearance to become inhomogeneous and noisy. This visual impression additionally becomes greater with increasing particle size.

The object was therefore to achieve a color-neutral silver effect which is accessible to the user in a simple manner without adversely affecting the luster or the appearance in the application.

This object is achieved by pigment mixtures in accordance with the present invention. The present invention accordingly relates to a silver and color-neutral pigment mixture comprising weakly colored silver interference pigments A and weakly colored interference pigments B of a complementary color. A complimentary color is one which, when combined with a silver pigment having a given color cast, renders that color cast absent to the eye.

For example, the determination of such a complimentary color as routine in the art as disclosed in, e.g., Greenstein, Pigment Handbook vol. 1, 1987, pgs. 829-858, which are incorporated by reference herein. See also, page 840 and FIG. 10, also incorporated by reference herein.

Pigment mixtures in accordance with the present invention are distinguished by a color-neutral silver impression, with the luster not being significantly impaired. The use of a weakly colored interference pigment of a complementary color simplifies blending, since the tolerance with regard to the amount of pigment employed is greater. Surprisingly, it has been found here that the amount of weakly colored interference pigment B of a complementary color that actually has to be employed corresponds to that of a corresponding, intensely colored pigment. Overall, the luster and the achievable effect in pigment mixtures in accordance with the present invention are thus greater than in pigment mixtures from the prior art.

Both the weakly colored silver interference pigments A and the weakly colored interference pigments B of a complementary color can have a multilayered structure. It is therefore possible to prepare a mixture which consists exclusively of multilayered interference pigments. In this way, the applicational properties and advantages of multilayered pigments, such as, for example, improved cleanability of powder coatings pigmented therewith, are retained.

Owing to the above-mentioned advantages, the pigment mixtures according to the invention are versatile. The present invention accordingly also relates to the use of the pigment mixtures in cosmetics, paints, coatings, plastics, films, in security printing, in security features in documents and identity cards, for coloring seed, for coloring foods or in medicament coatings and for the preparation of pigment compositions and dry preparations, and to cosmetics, paints, coatings, plastics, films, documents and identity cards, seed, foods or medicament coatings, pigment compositions and dry preparations comprising pigment mixtures in accordance with the present invention.

In the pigment mixture according to the invention, weakly colored silver interference pigments A and weakly colored interference pigments B of a complementary color are combined with one another in order to achieve a color-neutral silver mixture of high luster. The chroma C can be derived from measured L,a,b values (see F. Hofmeister, Colorimetric evaluation of pearlescent pigments, Congress “Mondial Couleur 85”, Monte Carlo, 1985). The value for the chroma C is given by the values for a and b in accordance with:

$$C = \sqrt{{a}_{{22.5}^{∘} / {22.5}^{∘} black card}^{2} + {b}_{{22.5}^{∘} / {22.5}^{∘} black card}^{2}}$$

For the purposes of the present invention, the value for the chroma C in intensely colored pigments is >10.0, while the value for the chroma C in weakly colored pigments is between 4.0 and 10.0, and color neutrality is defined as being when the value for the chroma C is <4.0. The value C for the chroma for the weakly colored interference pigments A and B is accordingly between 4.0 and 10, and the value C for the chroma of the pigment mixture according to the invention is <4.0.

In principle, the interference pigments A and B can have any conceivable shape, but they are preferably in flake form. The size of the interference pigments is not crucial per se. Flake-form interference pigments generally have a thickness of between 0.05 and 5 μm, in particular between 0.1 and 4.5 μm. The length and breadth dimension of the interference pigments can be between 1 and 250 μm, preferably in the range from 2 to 200 μm and very particularly preferably in the range from 2 to 100 μm. The size of the interference pigments can be matched to the requirements of the particular applications.

The interference pigments A and B are based on support materials which are coated with one or more layers comprising metal oxides, metal oxide hydrates, metal suboxides, metals, metal fluorides, metal nitrides, metal oxynitrides and/or mixtures thereof. The support material may comprise titanium oxides, synthetic or natural mica, phyllosilicates, glass, silicon dioxide, iron oxide and/or aluminium oxide, preferably synthetic or natural mica, glass, silicon dioxide or aluminium oxide. The coating with one or more layers comprising metal oxides, metal oxide hydrates, metal suboxides, metals, metal fluorides, metal nitrides, metal oxynitrides and/or mixtures thereof definitively determines the optical impression of the interference pigments. The metal oxide, metal oxide hydrate, metal suboxide, metal, metal fluoride, metal nitride, metal oxynitride layers or the mixtures thereof can be of low refractive index (refractive index <1.8) or of high refractive index (refractive index ≧1.8). Suitable metal oxides and metal oxide hydrates are all metal oxides or metal oxide hydrates to be applied as layers, such as, for example, aluminium oxide, aluminium oxide hydrate, iron oxide, tin oxide, cerium oxide, zinc oxide, zirconium oxide, chromium oxide, titanium oxide, in particular titanium dioxide, titanium oxide hydrate and mixtures thereof, such as, for example, ilmenite or pseudobrookite. Metal suboxides which can be employed are, for example, the titanium suboxides. Suitable metals are, for example, chromium, aluminium, nickel, silver, gold, titanium, copper or alloys, and a suitable metal fluoride is, for example, magnesium fluoride. Metal nitrides or metal oxynitrides which can be employed are, for example, the nitrides or oxynitrides of the metals titanium, zirconium and/or tantalum. Preference is given to the application to the support materials of metal oxide, metal, metal fluoride and/or metal oxide hydrate layers and very particularly preferably metal oxide and/or metal oxide hydrate layers. Furthermore, it is also possible for multilayered structures comprising metal oxide, metal oxide hydrate, metal or metal fluoride layers of high and low refractive index to be present, with layers of high and low refractive index preferably alternating.

In a preferred embodiment, the said support materials in the interference pigments A and B are coated with alternating layers of materials of high and low refractive index.

Particularly suitable materials of high refractive index are, for example, TiO₂, ZrO₂, ZnO, SnO₂, BiOCl and/or mixtures thereof. Particular preference is given to TiO₂. The thickness of these layers here is in each case from about 3 to 300 nm and preferably from 20 to 200 nm.

Particularly suitable materials of low refractive index are, for example, SiO₂, SiO(OH)₂, Al₂O₃, AlO(OH), B₂O₃, MgF₂ and/or mixtures thereof. Particular preference is given to SiO₂. The thickness of the individual layers comprising these materials is between 3 and 300 nm, preferably from 20 to 200 nm.

The outer layer of the interference pigments A and B which can be employed preferably consists of a material of high refractive index, in particular TiO₂. Starting from this condition, certain rules arise for the preferred structure of the interference pigments A and B. If the substrate consists of a material of high refractive index, such as, for example, TiO₂ or iron oxide, covering takes place with a layer of a material of low refractive index and a layer of a material of high refractive index. For the purposes of the present invention, it is assumed here that the coating preferably takes place in a sheathing manner, i.e. both the substrate and also all subsequent coated intermediate stages are coated on each side of the flakes in each coating step. The substrate material is preferably a material of low refractive index, in particular mica or SiO₂. In this case, pigments having three and seven layers, including the support material, satisfy the condition that the outer layer comprises a material of high refractive index. The interference pigments which can be employed preferably comprise a total of seven layers, including the support material.

In the case of the above-mentioned interference pigments A and B having a total of seven layers, a total of two sheathing layers comprising materials of high refractive index are present. These layers can consist of identical or different materials and have identical or different layer thicknesses. They preferably consist of identical materials, in particular TiO₂. Interference pigments A and B very particularly preferably to be employed in the present invention accordingly have the following structure:
TiO₂/SiO₂/TiO₂/support material (mica or SiO₂)/TiO₂/SiO₂/TiO₂

It is part of the expert knowledge of the person skilled in the art to select the above-mentioned materials and layer thicknesses in such a way that weakly colored silver interference pigments A and weakly colored interference pigments B of a complementary color are obtained. Pigments of the above-described type are known and commercially available, for example under the trade names Iriodin®, Xirallic®, Colorstream® or Timiron® from Merck KGaA, Darmstadt, and from other suppliers.

In a further embodiment of the present invention, the interference pigments A and B may furthermore be provided with an additional organic coating as outer layer. Examples of coatings of this type are given, for example, in EP 0 632 109, U.S. Pat. No. 5,759,255, DE 43 17 019, DE 39 29 423, DE 32 35 017, EP 0 492 223, EP 0 342 533, EP 0 268 918, EP 0 141 174, EP 0 764 191, WO 98/13426 or EP 0 465 805, the disclosure content of which is hereby incorporated by way of reference. Interference pigments comprising this organic coating, for example comprising organosilanes or organotitanates or organozirconates, additionally, besides the improved optical properties already mentioned, exhibit increased stability to weathering influences, such as, for example, moisture and light, which is of particular interest for industrial coatings and in the automobile sector.

The pigment mixture according to the invention is prepared by mixing the interference pigments A and B, with the proportions of the interference pigments A and B being selected in such a way that the value C for the chroma of the mixture becomes ≦4.0. A color-neutral silver mixture is only present from this point. The mixing operation as such can be carried out in all manners known to the person skilled in the art.

Owing to their advantageous properties, the pigment mixtures according to the invention are suitable for a wide range of applications. The invention therefore also relates to the use of the pigment mixtures according to the invention in cosmetics, paints, coatings, plastics, films, in security printing, in security features in documents and identity cards, for laser marking, for coloring seed, for coloring foods or in medicament coatings and for the preparation of pigment compositions and dry preparations.

In the case of cosmetics, the pigment mixtures according to the invention are particularly suitable for products in decorative cosmetics, such as, for example, nail varnishes, coloring powders, lipsticks or eye shadows. The pigment mixtures according to the invention can of course also be combined in the formulations with cosmetic raw materials and assistants of any type. These include, inter alia, oils, fats, waxes, film formers, preservatives and assistants which generally determine the applicational properties, such as, for example, thickeners and rheological additives, such as, for example, bentonites, hectorites, silicon dioxide, Ca silicates, gelatine, high-molecular-weight carbohydrates and/or surface-active assistants, etc. Formulations comprising the pigment mixtures according to the invention can belong to the lipophilic, hydrophilic or hydrophobic type. In the case of heterogeneous formulations with discrete aqueous and non-aqueous phases, the particles according to the invention may in each case only be present in one of the two phases or alternatively distributed over both phases.

The pH values of the aqueous formulations can be between 1 and 14, preferably between 2 and 11 and particularly preferably between 5 and 8. No limits are set for the concentrations of the pigment mixtures according to the invention in the formulation. They can be—depending on the application—between 0.001 (rinse-off products, for example shower gels) and 99% (for example luster-effect articles for particular applications). The pigment mixtures according to the invention may furthermore also be combined with cosmetic active ingredients. Suitable active ingredients are, for example, insect repellents, UV A/BC protection filters (for example OMC, B3, MBC), anti-ageing active ingredients, vitamins and derivatives thereof (for example vitamin A, C, E, etc.), self-tanning agents (for example DHA, erythrulose, inter alia), and further cosmetic active ingredients, such as, for example, bisabolol, LPO, ectoine, emblica, allantoin, bioflavonoids and derivatives thereof.

In the case of the use of the pigment mixtures in paints and coatings, all areas of application known to the person skilled in the art are possible, such as, for example, powder coatings, automobile paints, printing inks for gravure, offset, screen or flexographic printing, and for coatings in outdoor applications. The paints and coatings here can be, for example, radiation-curing, physically drying or chemically curing. A multiplicity of binders is suitable for the preparation of printing inks or liquid surface coatings, for example based on acrylates, methacrylates, polyesters, polyurethanes, nitrocellulose, ethylcellulose, polyamide, polyvinyl butyrate, phenolic resins, maleic resins, starch or polyvinyl alcohol, amino resins, alkyd resins, epoxy resins, polytetrafluoroethylene, polyvinylidene fluorides, polyvinyl chloride or mixtures thereof, in particular water-soluble grades. The coatings can be powder coatings or water- or solvent-based coatings, where the choice of the coating constituents is part of the general knowledge of the person skilled in the art. Common polymeric binders for powder coatings are, for example, polyesters, epoxides, polyurethanes, acrylates or mixtures thereof.

In addition, the pigment mixtures according to the invention can be used for the pigmenting of films and plastics, for example for agricultural sheeting, gift foils, plastic containers and mouldings for all applications known to the person skilled in the art. Suitable plastics for the incorporation of the pigment mixtures according to the invention are all common plastics, for example thermosets or thermoplastics. The description of the possible applications and the plastics which can be employed, processing methods and additives are given, for example, in RD 472005 or in R. Glausch, M. Kieser, R. Maisch, G. Pfaff, J. Weitzel, Perlglanzpigmente [Pearlescent Pigments], Curt R. Vincentz Verlag, 1996, 83 ff., the disclosure content of which is also incorporated herein.

In addition, the pigment mixtures according to the invention are also suitable for use in security printing and in security-relevant features for, for example, forgery-proof cards and identity papers, such as, for example, entry tickets, personal identity cards, banknotes, cheques and cheque cards, and for other forgery-proof documents. In the area of agriculture, the pigment mixtures can be used for coloring seed and other starting materials, in addition in the foods sector for pigmenting foods. The pigment mixtures according to the invention can likewise be employed for pigmenting coatings in medicaments, such as, for example, tablets or dragees.

The pigment mixtures according to the invention are likewise suitable for pigmenting films and in particular for use in blends with all known organic and/or inorganic colorants, such as, for example, organic dyes, organic pigments, inorganic single-layered or multilayered pigments, inorganic dyes or pigments. This enables novel color effects which can only be achieved with difficulty using the conventional metal-based pigments to be achieved in a simple manner. The pigment mixtures according to the invention can be mixed in any ratio with commercially available pigments and fillers.

Fillers which may be mentioned are, for example, natural and synthetic mica, nylon powder, pure or filled melamine resins, talc, glasses, kaolin, oxides or hydroxides of aluminium, magnesium, calcium, zinc, BiOCl, barium sulfate, calcium sulfate, calcium carbonate, magnesium carbonate, carbon, and physical or chemical combinations of these substances. There are no restrictions with respect to the particle shape of the filler; it can be, for example, flake-form, spherical or needle-shaped in accordance with requirements.

The pigment mixtures according to the invention are furthermore suitable for the preparation of flowable pigment compositions and dry preparations comprising one or more particles according to the invention, binders and optionally one or more additives. Dry preparations is also taken to mean preparations which comprise from 0 to 8% by weight, preferably from 2 to 8% by weight, in particular from 3 to 6% by weight, of water and/or a solvent or solvent mixture. The dry preparations are preferably in the form of pellets, granules, chips, sausages or briquettes and have particle sizes of 0.2-80 mm. The dry preparations are used, in particular, in the preparation of printing inks and in cosmetic formulations.

The present invention likewise relates to cosmetics, paints, coatings, plastics, films, documents and identity cards, seed, foods or medicament coatings, pigment compositions and dry preparations comprising the pigment mixtures according to the invention.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

### EXAMPLES

a) Preparation of a weakly colored greenish-silver pigment having the composition: TiO₂/SiO₂/TiO₂/mica/TiO₂/SiO₂/TiO₂

100 g of mica having a particle size of 10-60 μm are suspended in 2 l of demineralized water with stirring and heated to 75° C. The pH of the suspension is adjusted to 1.8 using 18% hydrochloric acid. 400 g of 30% titanium tetrachloride solution (prepared by dissolution of 200 g of titanium tetrachloride solution (w=60% by weight) in 200 g of demineralized water) are metered in, during which the pH is kept constant by simultaneous dropwise addition of 32% sodium hydroxide solution. When the addition is complete, the mixture is stirred for a further 15 minutes. The pH of the suspension is subsequently adjusted to 7.5 using 32% sodium hydroxide solution. A sodium water-glass solution (135 g of sodium water-glass solution comprising 27% by weight of SiO₂, dissolved in 135 g of demineralized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 1.8 using 18% hydrochloric acid, the mixture is stirred for a further 30 minutes, and 288 g of 30% titanium tetrachloride solution are added dropwise. The pH is kept constant at 1.8 by addition of 32% sodium hydroxide solution. The mixture is again stirred for a further 15 minutes. The product is filtered off, washed, dried, calcined at 850° C. and sieved through a 100 μm sieve.

After incorporation into nitrocellulose lacquer, paint cards of the pigment are prepared and measured coloristically (Phyma, geometries 45°/0° black card, 22.5°/22.5° black card, 45°/0° white card).

The chroma of the pigment is calculated from:

$$C = \sqrt{{a}_{{22.5}^{∘} / {22.5}^{∘} black card}^{2} + {b}_{{22.5}^{∘} / {22.5}^{∘} black card}^{2}}$$

The measure utilised for the luster is the L value measured on the black card (22.5°/22.5° geometry).

The pigment exhibits a greenish-silver interference (chroma C=6.95) with very high luster (L value: 88.03).

b) Preparation of a weakly colored reddish pigment having the composition: TiO₂/SiO₂/TiO₂/mica/TiO₂/SiO₂/TiO₂

100 g of mica having a particle size of 10-60 μm are suspended in 2 l of demineralized water with stirring and heated to 75° C. The pH of the suspension is adjusted to 1.8 using 18% hydrochloric acid. 400 g of 30% titanium tetrachloride solution (prepared by dissolution of 200 g of titanium tetrachloride solution (w=60% by weight) in 200 g of demineralized water) are metered in, during which the pH is kept constant by simultaneous dropwise addition of 32% sodium hydroxide solution. When the addition is complete, the mixture is stirred for a further 15 minutes.

The pH of the suspension is subsequently adjusted to 7.5 using 32% sodium hydroxide solution. A sodium water-glass solution (135 g of sodium water-glass solution comprising 27% by weight of SiO₂, dissolved in 135 g of demineralized water) is then added dropwise, during which the pH is kept constant at 7.5 by simultaneous metered addition of 18% hydrochloric acid. When the addition is complete, the mixture is stirred for a further 30 minutes. The pH of the suspension is then adjusted to 1.8 using 18% hydrochloric acid, the mixture is stirred for a further 30 minutes, and 800 g of 30% titanium tetrachloride solution are added dropwise. The pH is kept constant at 1.8 by addition of 32% sodium hydroxide solution. The mixture is again stirred for a further 15 minutes.

The product is filtered off, washed, dried, calcined at 850° C. and sieved through a 100 μm sieve.

After incorporation into nitrocellulose lacquer, paint cards of the pigment are prepared and measured coloristically (Phyma, geometries 45°/0° black card, 22.5°/22.5° black card, 45°/0° white card).

The pigment exhibits a weakly reddish interference (chroma C=7.07) with a very high luster for a red pigment (L value: 59.89).

c) Preparation of an intensely colored red interference pigment having the composition: TiO₂/mica/TiO₂

100 g of mica having a particle size of 10-60 μm are suspended in 2 l of demineralized water with stirring and heated to 75° C. The pH of the suspension is adjusted to 1.8 using 18% hydrochloric acid. 400 g of 30% titanium tetrachloride solution (prepared by dissolution of 200 g of titanium tetrachloride solution (w=60% by weight) in 200 g of demineralized water) are metered in, during which the pH is kept constant by simultaneous dropwise addition of 32% sodium hydroxide solution. When the addition is complete, the mixture is stirred for a further 15 minutes.

The product is filtered off, washed, dried, calcined at 850° C. and sieved through a 100 μm sieve.

After incorporation into nitrocellulose lacquer, paint cards of the pigment are prepared and measured coloristically (Phyma, geometries 45°/0° black card, 22.5°/22.5° black card, 45°/0° white card).

The pigment exhibits an intense red interference (chroma C=18.95) with lower luster (L value: 50.95) than the pigment from Example b).

d) Preparation of an intensely colored green interference pigment having the composition: TiO₂/mica/TiO₂

100 g of mica having a particle size of 10-60 μm are suspended in 2 l of demineralized water with stirring and heated to 75° C. The pH of the suspension is adjusted to 1.8 using 18% hydrochloric acid. 1060 g of 30% titanium tetrachloride solution (prepared by dissolution of 530 g of titanium tetrachloride solution (w=60% by weight) in 530 g of demineralized water) are metered in, during which the pH is kept constant by simultaneous dropwise addition of 32% sodium hydroxide solution. When the addition is complete, the mixture is stirred for a further 15 minutes.

The product is filtered off, washed, dried, calcined at 850° C. and sieved through a 100 μm sieve.

After incorporation into nitrocellulose lacquer, paint cards of the pigment are prepared and measured coloristically (Phyma, geometries 45°/0° black card, 22.5°/22.5° black card, 45°/0° white card).

The pigment exhibits a green interference (chroma C=15.15) with significantly lower luster (L value: 65.67) than the pigment from Example a).

### Example 1

### Preparation of a Color-Neutral Silver Pigment Mixture

The pigment powders from a) and b) are mixed in the ratio 2:1 (greenish-silver:reddish).

After incorporation into nitrocellulose lacquer, paint cards of the pigment mixture are prepared and measured coloristically (Phyma, geometries 45°/0° black card, 22.5°/22.5° black card, 45°/0° white card).

The pigment mixture according to the invention exhibits a color-neutral silver interference (chroma C=3.20) with very high luster (L value: 84.15).

### Comparative Example 1

### Preparation of a Color-Neutral Pigment Mixture with an Intensely Colored Red Interference Pigment

The pigment powders from a) and c) are mixed in the ratio 2:1 (greenish-silver:red).

After incorporation into nitrocellulose lacquer, paint cards of the pigment mixture are prepared and measured coloristically (Phyma, geometries 45°/0° black card, 22.5°/22.5° black card, 45°/0° white card).

The product exhibits a color-neutral silver interference (chroma C=3.09) with lower luster than the mixture according to the invention from Example 1 (L value: 78.04).

### Comparative Example 2

### Preparation of a Color-Neutral Pigment Mixture from an Intensely Colored Red and Green Interference Pigment

The pigment powders from c) and d) are mixed in the ratio 1:1. After incorporation into nitrocellulose lacquer, paint cards of the pigment mixture are prepared and measured coloristically (Phyma, geometries 45°/0° black card, 22.5°/22.5° black card, 45°/0° white card).

The product exhibits a color-neutral silver interference (chroma C=2.72) with no luster (L value: 59.17).

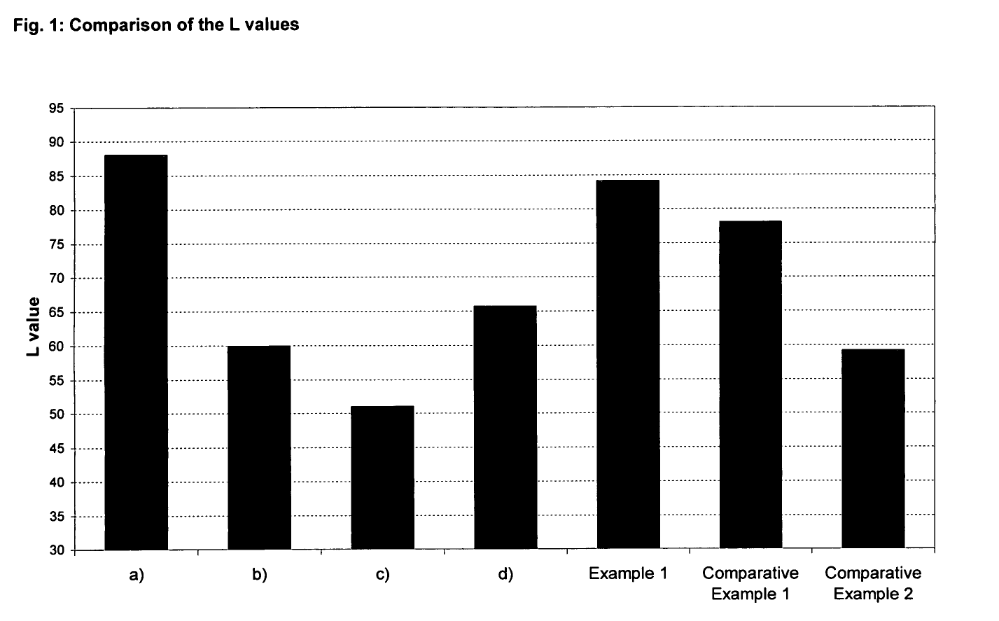

FIG. 1 shows that pigment mixtures according to the invention have higher luster than the mixtures obtained in accordance with the comparative examples.

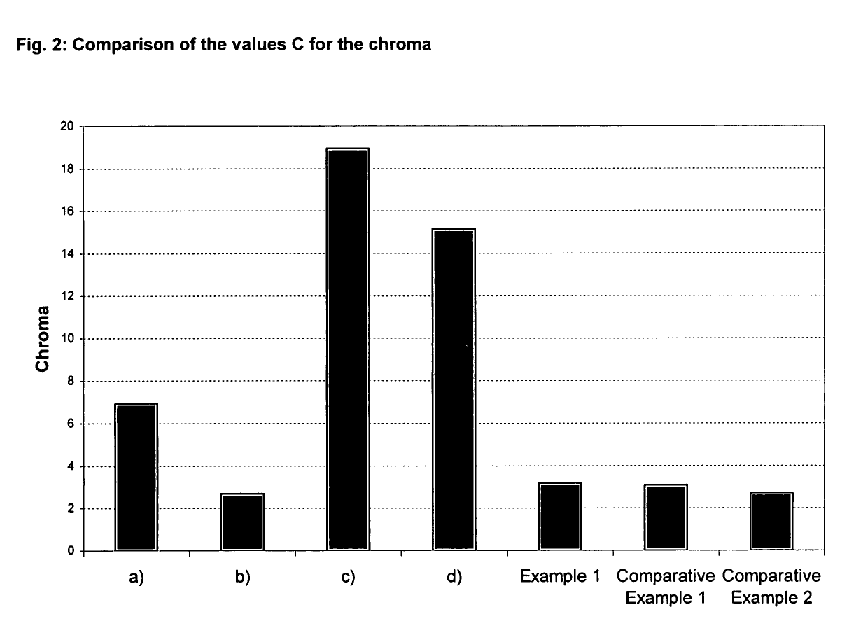

FIG. 2 gives a comparative overview of the values for the chroma C of pigments a)-d) and of the mixture from Example 1 and the comparative examples.

Combination in accordance with the invention of weakly colored silver pigments with weakly colored pigments of a complementary color gives color-neutral silver pigment mixtures with high luster.

The preceding examples can be repeated with similar success by substituting the generically or specifically described reactants and/or operating conditions of this invention for those used in the preceding examples.

The entire disclosure[s] of all applications, patents and publicaitons, cited above and below and of corresponding German Application No. 102004036297.1, filed Jul. 27, 2004 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A silver, color-neutral pigment mixture comprising a weakly colored silver interference pigment A and a weakly colored interference pigment B of a complementary color.

2. The pigment mixture according to claim 1, having a chroma value C of the weakly colored interference pigments A and B of 4.0 to 10.0.

3. The pigment mixture according to claim 1, having a chroma value C of the pigment mixture ≦4.0.

4. The pigment mixture according to claim 1, wherein interference pigments A and B comprise support materials which are coated with one or more layers comprising metal oxides, metal oxide hydrates, metal suboxides, metals, metal fluorides, metal nitrides, metal oxynitrides and/or mixtures thereof.

5. The pigment mixture according to claim 4, wherein the support material comprises titanium oxides, synthetic or natural mica, phyllosilicates, glass, silicon dioxide, iron oxide and/or aluminium oxide.

6. The pigment mixture according to claim 4, wherein the support materials are coated with alternating layers of materials of high and low refractive index.

7. The pigment mixture according to claim 6, wherein the materials of low refractive index are SiO₂, SiO(OH)₂, Al₂O₃, AlO(OH), B₂O₃, MgF₂ and/or mixtures thereof.

8. The pigment mixture according to claim 6, wherein the materials of high refractive index are TiO₂, ZrO₂, ZnO, SnO₂, BiOCl and/or mixtures thereof.

9. The pigment mixture according to claim 1, wherein the interference pigments A and B further comprise an additional organic coating as an outer layer.

10. In a cosmetic, paint, coating, plastic, film, security printing material, security feature in a document or identity card, seed, food, medicament coating, pigment composition or dry pigment preparation comprising a silver, color-neutral pigment, the improvement wherein the pigment is one according to claim 1.

11. A process for the preparation of a pigment composition, comprising combining a pigment mixture according to claim 1 and conventional excipients, and optionally drying to form a dry preparation.

12. A method of producing a color-neutral silver pigment, comprising combining a weakly colored silver interference pigment A and an amount of a weakly colored interference pigment B of a complementary color in an amount which has been determined to counter any color cast of pigment A.
